(19) United States
(12) Patent Application Publication
(10) Pub. No.: US 2011/0254825 A1
(43) Pub. Date: Oct. 20, 2011

(54) LIQUID CRYSTAL DISPLAY AND METHOD FOR DRIVING SAME

(75) Inventors: HUAN-XI PENG, Shenzhen (CN); SHA FENG, Shenzhen (CN)

(73) Assignees: CHIMEI INNOLUX CORPORATION, Miao-Li County (TW); INNOCOM TECHNOLOGY (SHENZHEN) CO., LTD., Shenzhen City (CN)

(21) Appl. No.: 12/962,839

(22) Filed: Dec. 8, 2010

(30) Foreign Application Priority Data
Apr. 14, 2010 (CN) 201010146906.6

(51) Int. Cl. G09G 5/00; G09G 3/36

(52) U.S. Cl. 345/212; 345/87

(57) ABSTRACT

An LCD includes a liquid crystal panel having a plurality of pixel units each including a liquid crystal capacitor, a scanning circuit for providing scanning signals to the pixel units, a data circuit for providing gray-scale voltage signals to the pixel units; and a timing controller for receiving at least one timing signal and providing a timing control signal to control a driving timing of the scanning circuit and the data circuit according to at least one timing signal. The timing controller outputs a reset control signal to the scanning circuit upon detecting that the liquid crystal display enters a power-off state based on the at least one timing signal. The reset control signal directs the scanning signal to activate all the pixel units to discharge liquid crystal capacitors. A method for driving a liquid crystal display is also provided.

### BACKGROUND

1. Technical Field

The present disclosure relates to liquid crystal displays (LCDs), and more particularly, to an LCD capable of limiting residual image occurrence, and a method for driving the LCD.

2. Description of Related Art

LCDs have the advantages of portability, low power consumption, and low radiation, and has been widely used in various portable information products such as notebooks, personal digital assistants (PDAs), video cameras and the likes.

An LCD generally includes a liquid crystal panel and a backlight module for illuminating the liquid crystal panel. The liquid crystal panel includes a plurality of pixel units, each of which includes a liquid crystal capacitor cooperatively formed by a pixel electrode, a common electrode, and a liquid crystal layer sandwiched therebetween. In operation, the pixel electrode and the common electrode receive a gray-scale voltage and a common voltage respectively. Due to a voltage difference between the gray-scale voltage and the common voltage, an electric field is generated therebetween. The electric field controls an amount of light beams transmit through the pixel unit, such that the pixel unit is driven to display a color with a desired gray-scale level, with gray level of the color is retained by a capacitor structure (i.e., the liquid crystal capacitor).

When the LCD is powered off, residual charges within the liquid crystal capacitors can not be released, and thus the electric fields remain for an extended time period. During this time period, light beams may still transmit through the pixel unit, and a so-called residual image occurs.

What is needed, therefore, is an LCD which can overcome the described limitations, and a method for driving the LCD.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a partial circuit diagram of an LCD according an embodiment of the present disclosure, the LCD including a timing controller.

FIG. 2 is a block diagram of the timing controller of the LCD of FIG. 1.

FIG. 3 shows waveforms of driving signals of the LCD of FIG. 1.

FIG. 4 is a flowchart of a method for driving an LCD according to an embodiment of the present disclosure.

### DETAILED DESCRIPTION

Reference will now be made to the drawings to describe specific exemplary embodiments of the present disclosure in detail.

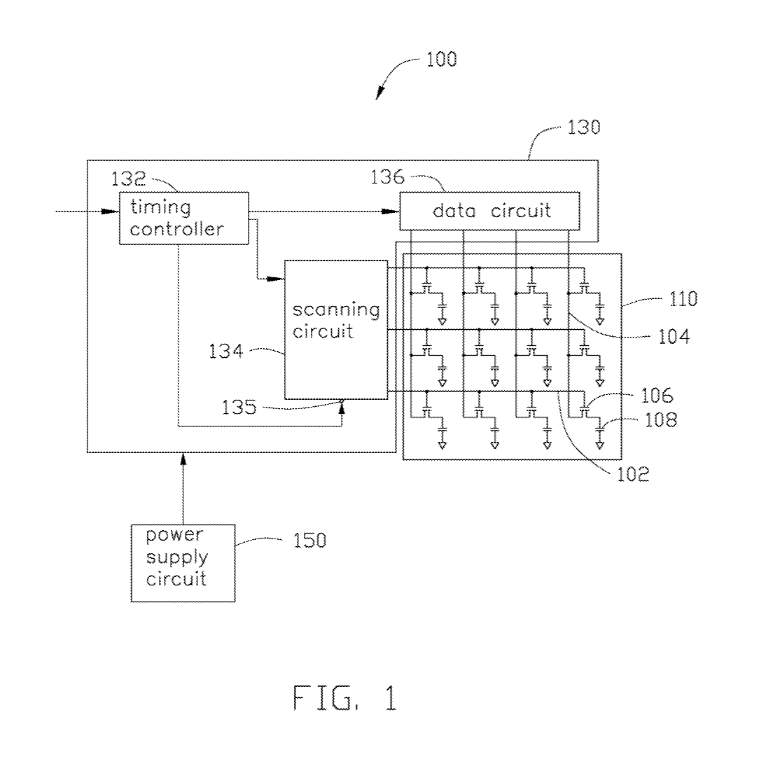

FIG. 1 is a circuit diagram of an LCD 100 according an embodiment of the present disclosure. The LCD 100 includes a liquid crystal panel 110, a driving circuit 130 for driving the liquid crystal panel 110, and a power supply circuit 150 for providing a power voltage to the driving circuit 130. The driving circuit 130 may include a scanning circuit 134 for providing scanning signals to the liquid crystal panel 110, a data circuit 136 for providing gray-scale voltage signals to the liquid crystal panel 110, and a timing controller 132 for controlling timing of the scanning circuit 134 and data circuit 136.

The liquid crystal panel 110 includes n rows of parallel scanning lines 102 (where n is a natural number), m columns of parallel data lines 104 perpendicular to the scanning lines 102 (where m is also a natural number), and a plurality of pixel units (not labeled) cooperatively defined by the crossing scanning lines 102 and data lines 104. The scanning lines 102 are electrically coupled to the scanning circuit 134 for receiving the scanning signals, and the data lines 104 are electrically coupled to the data circuit 136 for receiving the gray-scale voltage signals.

Each pixel unit includes a thin film transistor (TFT) 106 and a liquid crystal capacitor 108. The liquid crystal capacitor 108 may be formed by a pixel electrode, an opposite common electrode, and a liquid crystal layer sandwiched between the pixel electrode and the common electrode. A gate electrode of the TFT 106 is electrically coupled to a corresponding one of the scanning lines 102, and a source electrode of the TFT 106 is electrically coupled to a corresponding one of the data lines 104. Further, a drain electrode of the TFT 106 is electrically coupled to the liquid crystal capacitor 108.

The timing controller 132 may receive image data set from an external video source (not shown). The image data set is typically transmitted in a format of low voltage differential signal (LVDS), and hereinafter, the image data is named as LVDS data. The LVDS data may include timing signals and RGB (red, green, blue) data, in particular, the timing signals include a data enable signal (DENA signal), a horizontal synchronous signal (Hsync signal), and a vertical synchronous signal (Vsync signal). Each of the DENA signal, the Hsync signal, and the Vsync signal is typically a periodical square-wave pulse formed by a high level signal (i.e., “1”) and a low level signal (i.e., “0”) alternating with each other. The DENA signal corresponds to valid RGB data, and indicates a time period for activating a pixel unit. Moreover, the Hsync signal indicates a time period for scanning a row of pixel units, and the Vsync signal indicates a timing period for scanning a frame of pixel units.

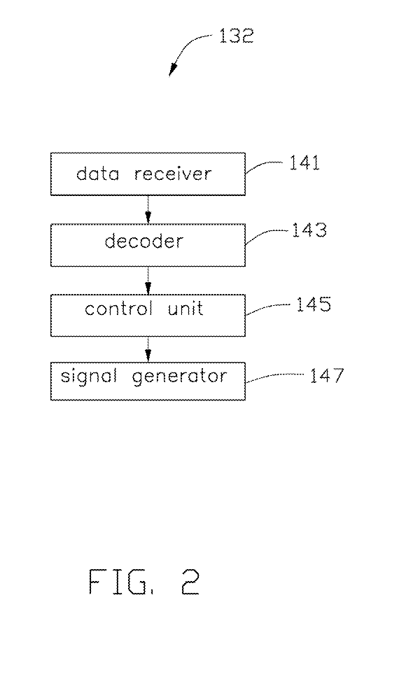

Referring also to FIG. 2, in one embodiment, the timing controller 132 may include a data receiver 141, a decoder 145, a control unit 145, and a signal generator 147 electrically coupled in series. The data receiver 141 may receive the LVDS data and forward the LVDS data to the decoder 145. The decoder 145 may decode the LVDS data, separate the timing signals from the RGB data, and output the timing signals to the control unit 145. The control unit 145 may parse the timing signals, when the control unit 145 detects one of the timing signals (i.e., the DENA signal, the Hsync signal, or the Vsync signal) is abnormal, the control unit 145 may control the signal generator 147 to generate and output a reset control signal to a reset terminal 135 of the scanning circuit 134. The reset control signal may be used to control the scanning circuit 134 to switch all the pixel units of the liquid crystal panel 110 on simultaneously, so as to release the residual charges within the liquid crystal capacitors 108.

In one embodiment, when the control unit 145 determines that the DENA signal presents as a continuous low voltage signal over a predetermined time period, rather than a periodical square-wave pulse signal, the control unit 145 may determine that the DENA signal is abnormal. The predetermined time period can be set according to a configuration of the liquid crystal panel 110, for example, when the liquid crystal panel 110 has a physical resolution of 1366*768 and a refresh frequency of 60 Hz, the predetermined time period can be set as from about 2.4 ms to about 3.0 ms, or preferable, about 2.8 ms. In an exemplary embodiment, the predetermined time period is desired to be greater than a time period corresponding to invalid RGB data in a frame period as well as a time period corresponding to invalid RGB data between two sequent frame period.

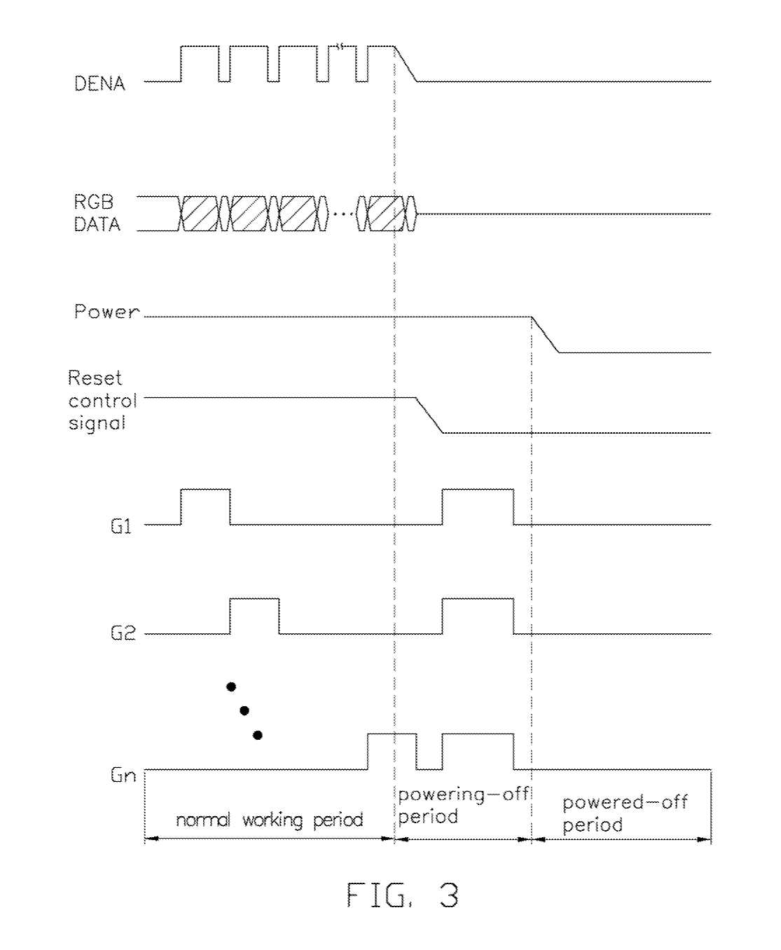

FIG. 3 is waveforms of driving signals of the LCD 100, which illustrates the DENA signal and the RGB data obtained from the LVDS data, the power voltage provided by the power supply circuit 150, the reset control signal provided by the timing controller 132, and the scanning signals provided by the scanning circuit 134. Referring also the FIG. 3, an operation of the LCD 100 is as follows.

When the LCD 100 is in a normal working state, the power supply circuit 150 provides the power voltage to the driving circuit 120. The LVDS data is received by the timing controller 132, and the control unit 145 of the timing controller 132 detects that DENA signal is a normal square-wave pulse signal and thereby controlling the signal generator 147 to maintain an output (i.e., the reset control signal) as an invalid high voltage signal. Moreover, the timing controller 132 also generates a timing control signal according to the DENA signal, the Hsync signal, and the Vsync signal, and outputs the timing control signal to the scanning circuit 134 and the data circuit 136. In addition, the timing controller 132 also output the RGB data to the data driver 136 after converting the LVDS-formatted RGB data into reduced swing differential signaling (RSDS) format.

Upon receiving the timing control signal, the scanning circuit 134 generates and applies scanning signals to the scanning line 102, so as to switch on the TFTs 106 of the pixel units and thereby activating the pixel units row by row. The data circuit 136 converts the received RGB data into gray-scale voltages signals and output the gray-scale voltages signals to charge the liquid crystal capacitors 108 of the activated pixel units. Accordingly, each pixel unit is driven to a color with a desire gray-scale level, and the aggregation of colors displayed by all the pixel units of the liquid crystal panel 110 simultaneously constitutes an image viewed by a user of the LCD 100.

Moreover, when the LCD 100 enters a power-off state (e.g., such power-off state may be triggered by a user by use of a power button of the LCD 100), the DENA signal may be invalid and the RGB data has disappeared. The power-off state may include a powering-off period greater than that of a period of the scanning signal, and a powered-off period after the powering-off period. In the powering-off period, the power circuit 150 retains to provide the power voltage signal, i.e., the power voltage signal is delayed for cutting off in the power-off period, and the timing controller 132 may detect that the timing signals in the LVDS data is abnormal, for example, the control unit 145 of the timing controller 132 detects that the DENA signal is a continuous low voltage signal over a predetermined time period, thus, the control unit 145 of the timing controller 132 generates and outputs a valid reset control signal (e.g., a low voltage signal) to the reset terminal 135 of the scanning circuit 134. In response to the reset control signal, the scanning circuit 134 may provide a reset signal to all the scanning lines 102, so as to switch all row of pixel units on simultaneously. As such, residual charges within the liquid crystal capacitors 108 can be released in the power-off period for a short time, and the residual image phenomenon that might otherwise exist can be weakened or even eliminated.

Furthermore, after the powering-off period, the powered-off period starts and the power circuit 150 stops the provision of the power voltage signal, and the LCD 100 is powered off completely.

It is noted, generally, the power circuit 150 includes energy accumulating elements such as capacitors or inductors, which are capable of storing electrical energy. Due to the energy accumulating elements, the power voltage signal may be retained for a short time period when power supply is interrupted, that is, when the power circuit 150 starts to stop providing the power voltage signal, the energy accumulating elements can delay the power voltage signal for being removed. Therefore, in an alternative embodiment, the power circuit 150 may stop supply of the power voltage signal immediately when the LCD 100 enters the power-off state, with the stored electrical energy in the energy accumulating elements, the power voltage signal can be maintained in the power-off period.

Moreover, when the LCD 100 is powered off, the Hsync signal and the Vsync signal are terminated and may also become low voltage signals. Accordingly, in another alternative embodiment, the timing controller 132 may generate and output the reset control signal to the scanning circuit 134 upon detecting that the Hsync signal is abnormal, for example, the Hsync signal represents as a continuous low voltage signal over another reference time period. In yet another alternative embodiment, the timing controller 132 may generate and output the reset control signal to the scanning circuit 134 upon detecting that the Vsync signal is abnormal, for example, the Vsync signal represents as a continuous low voltage signal over yet another reference time period. Both of these two alternative embodiment can also enable the residual charges within the liquid crystal capacitors 108 to be released in the power-off period and thereby limit or even eliminate the residual image occurrence.

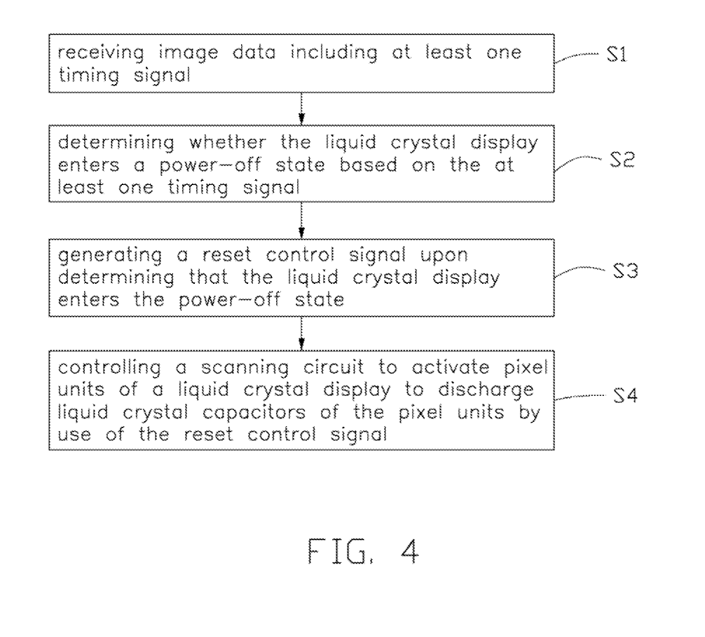

Further, referring to FIG. 4, a method for driving an LCD may include steps as follows. In step S1, image data including at least one timing signal is received by a timing controller. In step S2, the timing controller determines whether the liquid crystal display enters a power-off state based on the at least one timing signal. In step S3, a reset control signal is generated by the timing controller when the timing controller determines that the liquid crystal display enters the power-off state. In step S4, the timing controller controls a scanning signal to activate all pixel units of a liquid crystal display to discharge liquid crystal capacitors of the pixel units by use of the reset control signal.

Details of Steps S1-S4 can be found in the above description on the operation of the LCD 100. For example, in one embodiment, the image data received by the timing controller is LVDS data including RGB data and the at least one timing signal, the at least one timing signal comprises a data enable signal, a horizontal synchronous signal, and a vertical synchronous signal.

Moreover, step S2 may include the following sub-steps: the timing controller decoding the LVDS data to separate the at least one timing signal from the RGB data; the timing controller detecting whether the at least one timing signal represents as a continuous low voltage signal over a predetermined time period, and if so, the timing controller determining that the liquid crystal display enters a power-off state. In addition, the predetermined time period is greater than a time period corresponding to invalid RGB data in a frame period as well as a time period corresponding to invalid RGB data between two sequential frame periods.

Furthermore, the power-off state of the liquid crystal display may include a powering-off period and a powered-off period, and during the powering-off period, a power supply circuit may retain to provide a power voltage signal to both the timing controller and the scanning circuit.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display, comprising:
a liquid crystal panel comprising a plurality of pixel units, each pixel unit comprising a liquid crystal capacitor;
a scanning circuit configured to provide scanning signals to the pixel units;
a data circuit configured to provide gray-scale voltage signals to the pixel units; and
a timing controller configured to receive at least one timing signal, and provide a timing control signal to control a driving timing of the scanning circuit and the data circuit according to at least one timing signal;
wherein the timing controller outputs a reset control signal to the scanning circuit upon detecting that the liquid crystal display enters a power-off state based on the at least one timing signal, wherein the reset control signal is configured for controlling the scanning signal to activate all the pixel units to discharge liquid crystal capacitors.

2. The liquid crystal display of claim 1, wherein the at least one timing signal comprises a data enable signal, and the timing controller determines that the liquid crystal display enters the power-off state upon detecting that the data enable signal represents a continuous low voltage signal over a first predetermined time period.

3. The liquid crystal display of claim 2, wherein the first predetermined time period is greater than a time period corresponding to invalid RGB data in a frame period.

4. The liquid crystal display of claim 3, wherein the first predetermined time period is also greater than a time period corresponding to invalid RGB data between two sequent frame periods.

5. The liquid crystal display of claim 1, wherein the at least one timing signal comprises a horizontal synchronous signal, and the timing controller determines that the liquid crystal display enters the power-off state upon detecting that the horizontal synchronous signal represents a continuous low voltage signal over a second predetermined time period.

6. The liquid crystal display of claim 1, wherein the at least one timing signal comprises a vertical synchronous signal, and the timing controller determines that the liquid crystal display enters the power-off state upon detecting that the vertical synchronous signal represents a continuous low voltage signal over a third predetermined time period.

7. The liquid crystal display of claim 1, wherein the timing controller comprise a data receiver configured to receive LVDS data comprising the at least one timing signal, a control unit configured to parse the at least one timing signal and determine whether the at least one timing signal indicates the liquid crystal display enters the power-off state, and a signal generator configured to generate and output the reset control signal according to an instruction of the control unit.

8. The liquid crystal display of claim 7, wherein the LVDS data further comprises RGB data, and the timing controller further comprises a decoder configured to decode the LVDS data to separate the at least one timing signal from the RGB data, and output the at least one timing signal to the control unit.

9. The liquid crystal display of claim 7, wherein the at least one timing signal comprises a horizontal synchronous signal, a vertical synchronous signal, and a data enable signal.

10. The liquid crystal display of claim 1, further comprising a power supply circuit configured to provide a power voltage signal to the scanning circuit, the data circuit, and the timing control circuit.

11. The liquid crystal display of claim 10, wherein the power supply circuit retains to provide the power voltage signal for a fourth predetermined time period when the liquid crystal display enters the power-off state.

12. The liquid crystal display of claim 11, wherein a length of the fourth predetermined time period is greater than that of a period of the scanning signal.

13. The liquid crystal display of claim 10, wherein the power supply circuit comprises energy accumulating elements capable of storing electrical energy, and the power supply circuit stop a provision of the power voltage signal immediately when the liquid crystal display enters the power-off state.

14. The liquid crystal display of claim 13, wherein the energy accumulating elements maintain an output of the power voltage signal by use of the electrical energy stored therein during a powering-off period of the liquid crystal display.

15. The liquid crystal display of claim 14, wherein the energy accumulating elements comprises at least one of capacitors or inductors.

16. A method for driving a liquid crystal display, comprises:
receiving image data that comprises at least one timing signal;
determining whether the liquid crystal display enters a power-off state based on the at least one timing signal;
generating a reset control signal upon determining that the liquid crystal display enters the power-off state; and
controlling a scanning circuit to activate pixel units of a liquid crystal display to discharge liquid crystal capacitors of the pixel units by use of the reset control signal.

17. The method of claim 16, wherein the image data is LVDS data comprising RGB data and the at least one timing signal, and the at least one timing signal comprises a data enable signal, a horizontal synchronous signal, and a vertical synchronous signal.

18. The method of claim 17, wherein the determining whether the liquid crystal display enters a power-off state comprises:
decoding the LVDS data to separate the at least one timing signal from the RGB data; and
detecting whether the at least one timing signal represents a continuous low voltage signal over a predetermined time period, and determining that the liquid crystal display enters a power-off state if the at least one timing signal represents the continuous low voltage signal over the predetermined time period.

19. The method of claim 18, wherein the predetermined time period is greater than a time period corresponding to invalid RGB data in a frame period and a time period corresponding to invalid RGB data between two sequent frame period.

20. The method of claim 16, wherein the power-off state of the liquid crystal display comprises a powering-off period and a powered-off period, and the method further comprising: retaining to provide a power voltage signal from a power supply circuit during the powering-off period.
